(19) United States
(12) Patent Application Publication
(10) Pub. No.: US 2024/0224930 A1
(43) Pub. Date: Jul. 11, 2024

(54) PORTABLE PET CRATE WITH VENTILATED PET SAFETY CARRIER

(71) Applicant: Robert Wade Bullock, Williston, FL (US)

(72) Inventor: Robert Wade Bullock, Williston, FL (US)

(21) Appl. No.: 18/151,351

(22) Filed: Jan. 6, 2023

(51) Int. Cl. A01K 1/02

(52) U.S. Cl. CPC A01K 1/0254; A01K 1/0245

(57) ABSTRACT

Embodiments described herein relate to a pet crate safety system. The pet crate safety system can include a housing including a plurality of walls, the plurality of walls arranged to form a first volume. The pet crate safety system can further include a mount arranged on a first surface of a wall of the plurality of walls. The pet crate safety system can further include a ventilated pet safety carrier configured to be removably mounted to the mount and arranged in the volume, the ventilated pet safety carrier further configured to form a second volume when attached to the mount.

### BACKGROUND

A pet crate is a small carriage, such as a box or cage, that a pet owner can use to transport a pet. A pet crate can be configured to provide a pet with a safe and comfortable journey along with an owner. A variety of animals can be transported using a pet crate, including a cat, a dog, a rodent, and a pig.

### BRIEF DESCRIPTION OF THE DRAWINGS

FIG. 1 is an illustration of a pet crate with a mounted mesh liner pet safety carrier, according to one or more embodiments.

FIG. 2 is an illustration of a pet crate, according to one or more embodiments.

FIG. 3 is an illustration of a compartment formed by a pet carrier, according to one or more embodiments.

FIG. 4 is an illustration of a ventilated pet safety carrier, according to one or more embodiments.

FIG. 5 is an illustration of a ventilated pet safety carrier, according to one or more embodiments.

FIG. 6 is a process flow for fabricating a portable pet crate with a ventilated pet safety carrier, according to one or more embodiments.

### DETAILED DESCRIPTION

The following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Many families consider their pets to be full-fledged members of the family. Pet owners are tasked with maintaining their pet's health, which includes trips to and from a veterinarian. A pet crate is a physical carriage that an owner can use to transport their pet to and from the veterinarian. A pet crate can include a housing that includes multiple walls that form a space for a pet while being transported to and from the veterinarian. The pet crate can further include a gate to allow the pet to enter and leave the housing. Some pet crates have a housing with a removable top, such that a pet can be removed using the gate, or by removing the top of the housing. Other pet crates have single structure housing, such that the pet can only leave or enter through the gate.

A pet owner can take their pet to the veterinarian in the pet crate from the lobby to the front desk, and into the patient room. Once the pet has been brought into the patient room, the veterinarian's assistant or the veterinarian may need to remove the pet from the pet crate for examination. For example, the veterinarian's assistant or the veterinarian may need to weigh the pet, perform a visual inspection, give the pet a medication, or perform an operation. In each of these instances, the veterinarian's assistant or the veterinarian can either remove the pet from the gate or by removing the top of the housing. In some instances, the pet can be startled or otherwise reluctant to be removed from the place of safety and into an unknown patient room to be examined. This can lead to the pet being uncooperative to any attempt by the veterinarian's assistant or the veterinarian to remove the pet from the pet crate. Furthermore, once the pet has been removed from the pet crate, it can be difficult for a veterinarian's assistant or the veterinarian to perform their examination on an uncooperative pet. For example, the pet can get loose and run around the patient room or otherwise react defensively to any attempts at examination. This can lead to injuries for the pet, the veterinarian's assistant, or the veterinarian.

The embodiments described herein address the above addressed issues by providing a pet crate with a removable and ventilated pet safety carrier. The pet safety carrier can be a structure that can form a living space for the pet while being transported to the veterinarian, being tended to by the veterinarian's assistant or the veterinarian and being transported back home. For example, the pet safety carrier can be a structure formed from a perforated material, such as a mesh liner, which can be used to transport the pet. The pet safety carrier can, for example, removably attached to mounts arranged on an inner surface of the per crate housing. The pet safety carrier can include an opening to allow a pet to enter or leave the pet safety carrier. In some embodiments, the opening can be opened or closed, such as with a zipper, Velcro, clip, drawstring, or other appropriate feature. While attached to the mounts, the pet safety carrier opening can be enlarged to allow a pet to enter the pet safety carrier. The opening can further be arranged proximate to the pet crate gate, or in other instances, proximate to the top of the housing, similar to the upper opening of a duffel bag. When the owner is ready to transport the pet, the owner can place the pet inside the pet safety carrier through the opening. For example, the owner can open the gate and get the pet into the pet safety carrier through the gate and the pet safety carrier opening. In other instances, the owner can remove the top housing of the pet crate and place the pet into the pet safety carrier opening. Once the pet is in the pet safety carrier, the owner can reduce the size of the opening to secure the pet in the pet safety carrier. For example, the owner can pull the drawstring to reduce the size of the opening to keep the pet from getting out of the pet safety carrier. The owner can then either close the gate or reinstall the top housing of the pet crate and take the pet to the veterinarian.

It should be appreciated that although the herein embodiments are described with respect to using the portable pet crate and ventilated safety carrier with respect to transporting a pet to a veterinarian's office, other uses are contemplated. For example, the portable pet crate and ventilated safety carrier can be used to transport the pet to other destinations, such as a pet groomer, a dog park, or boarding facility.

The veterinarian's assistant or the veterinarian can open the pet crate. For example, by either opening the gate or removing the top housing of the pet crate. Once the pet crate is opened, the pet can remain in the pet safety carrier. The veterinarian's assistant or the veterinarian can remove the pet safety carrier with the pet inside from the pet crate and place the pet inside the pet safety carrier on an observation table. From there, the veterinarian's assistant or the veterinarian can examine the pet. For example, the veterinarian's assistant or the veterinarian can weigh the pet, perform a visual inspection of the pet through a perforation, and administer an injection, all while the pet remains in the pet safety carrier. In some instances, the pet safety carrier can include additional features such as a targeted opening, which can be opened or closed using a zipper, Velcro, clip, button, or other fastener. The targeted opening can be positioned to allow a veterinarian's assistant or the veterinarian to target one or more areas on the pet's body. One or more targeted openings can be arranged to allow a veterinarian's assistant or the veterinarian to pull out and expose, for example, an arm or leg through the targeted opening. For example, the veterinarian may need an unobstructed view of an arm or a leg and can expose the leg through the targeted opening while the rest of the pet remains in the pet safety carrier.

In addition to a targeted opening, the pet safety carrier can also include one or more safety restraints. For example, the pet safety carrier can include one or more straps that the veterinarian's assistant or the veterinarian can be used to restrain an uncooperative pet. As an example, a fractious cat can be extremely resistant to any form of interaction with a person. A situation, in which the cat is hissing, biting, scratching, and moving about can be dangerous for both the human and the cast. Keeping the cat inside the pet safety carrier can create a barrier between the cat's teeth and claws and the human. The safety restraints can provide an additional safety feature to prevent the cat from harming the human or from self-harm. The straps can include a fastening feature, such as a clip or Velcro to keep the straps in place. The safety restraint can be arranged on an outer surface of the pet safety carrier. The veterinarian's assistant or the veterinarian can wrap the safety restraint around the pet and then fasten the safety restraint with the fastening feature. In some instances, the veterinarian's assistant or the veterinarian can use the targeted opening and the safety restraint together. For example, the veterinarian's assistant can open a targeted opening and draw a pet's leg from the opening. The veterinarian's assistant can further wrap one or more safety restraints around the pet's other leg(s) and/or arms to keep the pet still. Once the veterinarian's assistant is finished examining the leg, the assistant can move the leg back into the pet safety carrier through the targeted opening and close the opening. The veterinarian's assistant can further loosen the safety restraints to allow the pet to move about the pet safety carrier.

If permissible, the pet can remain in the pet safety carrier throughout the veterinarian appointment. In this sense, the veterinarian's assistant or the veterinarian can perform the examination, while protected from a pet scratching or biting the veterinary office staff. Furthermore, the pet can remain in a breathable pet safety carrier, while still maintaining visibility to the outside of the pet safety carrier. Once the examination is complete, the veterinarian's assistant or the veterinarian can place the pet back into the pet crate while in the pet safety carrier and either close the gate or reinstall the top housing. The pet owner can take their pet home in the pet crate. Once home, the owner can take their pet out of the pet crate and pet safety carrier and remount the pet safety carrier in the pet crate.

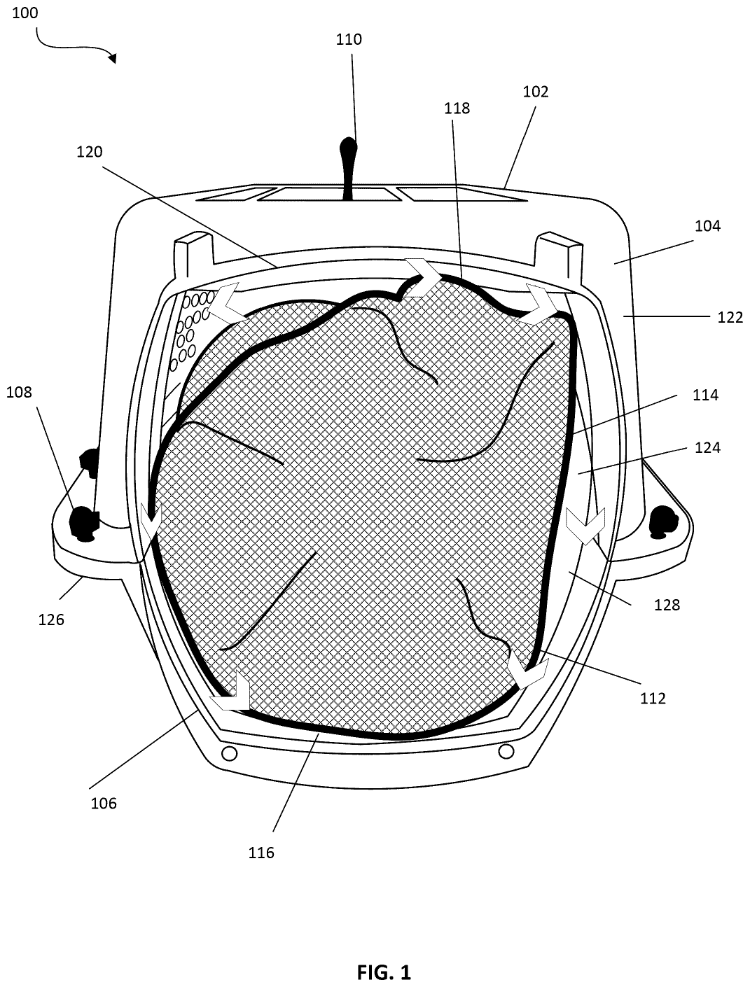

FIG. 1 is an illustration of a pet crate with a mounted pet safety carrier, according to one or more embodiments. A pet crate 100 can include a housing 102 that includes a first housing 104 and a second housing 106 that can be connected to the first housing 104. For example, the first housing 104 can be connected to the second housing 106 by one or more carrier fasteners 108, such as a bolt. In some embodiments, the first housing 104 can further include a flap on a top surface of the first housing. The flap can be opened without detaching the first housing 104 from the second housing 106. In these embodiments, a user can retrieve a pet by opening the flap and retrieving the pet from an opening in the first housing 104. In other embodiments, the housing 102 can include single housing, such that rather than have a first housing connected to a second housing, the housing 102 can be fabricated as a single structure. The pet crate 100 can further include a handle 110 connected to the housing 102 for permitting a user to carry the pet crate 100.

A pet safety carrier 112 can be arranged inward from a surface of the pet crate 100. For example, the pet safety carrier 112 can be arranged in a living space formed by the pet crate 100. The pet safety carrier can be a ventilated pet safety carrier (e.g., a mesh liner pet safety carrier) for allowing air to pass to and from the pet safety carrier 112. The pet safety carrier 112 can be in an expanded state or a collapsed state. The expanded state can include a stretched state or an unstretched state. In the expanded state, the pet safety carrier 112 can be configured to have a volume that creates a living space for the pet. This can allow a pet to see out of the pet safety carrier 112 and to breathe while in the pet safety carrier 112. The pet safety carrier 112 can further be fabricated from a material (e.g., polyester or nylon) that provides comfort to the pet while in the pet safety carrier 112. The pet safety carrier 112 can include a pet safety carrier opening 114 for allowing a pet to enter and leave the pet safety carrier 112. The pet safety carrier 112 can include one or more mechanisms to open or close the pet safety carrier opening 114. As illustrated, the pet safety carrier opening 114 includes a drawstring 116 inserted at a circumference of the pet safety carrier opening 114. The drawstring 116 can be used to open or close the pet safety carrier opening 114. For example, a user can pull the drawstring 116 away from the pet safety carrier 112 to reduce the size of the pet safety carrier opening 114. This can prevent a pet inside the pet safety carrier 112 from getting out of the pet safety carrier 112. The user can also pull at the opening to increase the size of the pet safety carrier opening 114. This can allow a pet to enter the pet safety carrier 112 or leave the pet safety carrier 112. It should be appreciated that in other embodiments, the pet safety carrier opening 114 can be opened or closed using other mechanisms, such as a zipper, Velcro, clip, button, or other fastening mechanisms.

The pet crate 100 can further include an array of mounts, including a first mount 118 for securing the pet safety carrier 112 to the pet crate 100. The first mount 118 can be connected to the pet crate 100 and arranged inward from a surface of the pet crate 100. The first mount 118 can assume various forms, such as a hook, Velcro, clip, button, strap, or other mount operable to mount the pet safety carrier 112 to a surface of the pet crate 100. For example, the first mount 118 can include a Velcro strap attached to the pet crate 100 and the pet safety carrier 112 can include an opposing Velcro strap that can be removably attached to the Velcro strap attached to the pet crate. As illustrated, the first mount 118 can include a hook that can receive a portion of the pet safety carrier 112. For example, the circumference, including the drawstring, can be received by the first mount 118, such that the mount holds the pet safety carrier 112 proximate to the pet crate 100. In some embodiments, the pet crate 100 can include multiple mounts that hold the pet safety carrier opening 114 open to permit a pet to enter or leave the pet safety carrier 112. The pet crate 100 can include multiple walls (e.g., side walls, bottom walls, top walls). One wall of the pet crate can include a pet crate opening 120. In some embodiments, the pet crate opening 120 is connected to a gate (e.g., a slideable gate or a rotatable gate) that can prevent a pet from entering or leaving the pet crate 100. The pet crate 100 can include an array of mounts arranged on a surface of the pet crate 100 can be proximate to the pet crate opening 120. The multiple mounts arranged proximate to the pet crate opening 120 can each receive a portion of the pet safety carrier 112, such that the pet safety carrier opening 114 can be wide enough to allow a pet to enter or leave the pet safety carrier 112. Each wall can further include an outer surface 122 and an inner surface 124. The pet crate 100 can further include additional mounts that can be arranged on the pet crate 100 and inward from a surface of the pet crate (e.g., connected to an inner surface of a wall). For example, a mount can be arranged on an inner surface 124 of the pet crate 100 opposite the handle 110. Another mount can be arranged on an inner surface of the pet crate opposite of a carrier fastener 108. These mounts can be configured to receive a body of the pet safety carrier 112, such that the pet safety carrier 112 is expanded to form a volume that creates a living space for the pet to enter and rest inside the pet safety carrier 112.

A user can place a pet into the pet safety carrier 112 through various methods. For example, the user can removably connect the pet safety carrier 112 to one or more mounts of the pet crate 100. The first mount 118 can receive the pet safety carrier 112, such that the pet safety carrier opening 114 is wide enough to permit a pet to enter or leave. As illustrated, the pet safety carrier opening 114 is proximate to the pet crate opening 120. However, as described, a pet crate 100 can include a removable first housing 104 or a flap. In some embodiments, a user can elect to attach the pet safety carrier 112 to the mount, such that the pet safety carrier opening 114 is proximate to the flap, such that a user can open the flap and place the pet into the pet safety carrier 112 from a top of the pet crate 100, rather than through the pet crate opening 120. In other embodiments, the mounts can be arranged on the second housing 106, such as inward from a wing 126. In these embodiments, the pet safety carrier opening 114 can be exposed by removing the first housing 104 from the second housing 106 or opening a flap of the first housing 104. The user can either open the flap or remove the first housing 104 and place the pet into the pet safety carrier 112 from above the pet crate 100. For illustration, a second mount 128 is shown. As seen, the second mount is connected to an inner surface of the second housing 106. The second mount 128 is illustrated as not connected to the pet safety carrier 112, and the pet safety carrier 112 is collapsed inward from the inner surface of the second housing 106. As illustrated, the pet crate 100 can include a third mount 130 that is also not removably connected to the pet safety carrier 112. As seen, the pet safety carrier 112 is collapsed about the third mount 130. As further seen, the pet crate 100 can include a fourth mount 132 that is removably connected to the pet safety carrier 112. As seen the fourth mount 132 is holding the pet safety carrier 112 in an expanded state and close to an inner surface 124 of the housing 102. Therefore, even if the pet safety carrier 112 is not attached to each mount of the array of mounts, the pet safety carrier 112 can be in an expanded state that allows the pet to enter and remain in a volume created by the pet safety carrier 112.

It should be appreciated that the mounts can be arranged in various configurations about the pet crate opening 120. Furthermore, the pet safety carrier 112 can be removably connected to one or more mounts to cause the pet safety carrier 112 to be in an expanded state. For example, as illustrated, the pet safety carrier 112 is removably attached to a subset of mounts, including among the first mount 118 and the fourth mount 132, of an array of mounts and remains in an expanded state. It should be appreciated that the pet safety carrier 112.

A user can further remove the pet from the pet crate 100 through various methods. For example, a user can retrieve a pet in the pet safety carrier 112 from the pet crate opening 120. In some instances, the user can open a gate to expose the pet crate opening 120, and then remove the pet safety carrier 112. The pet can be in the pet safety carrier 112. A user can also open a flap on the first housing 104 to remove the pet safety carrier 112 from an opening in the first housing 104.

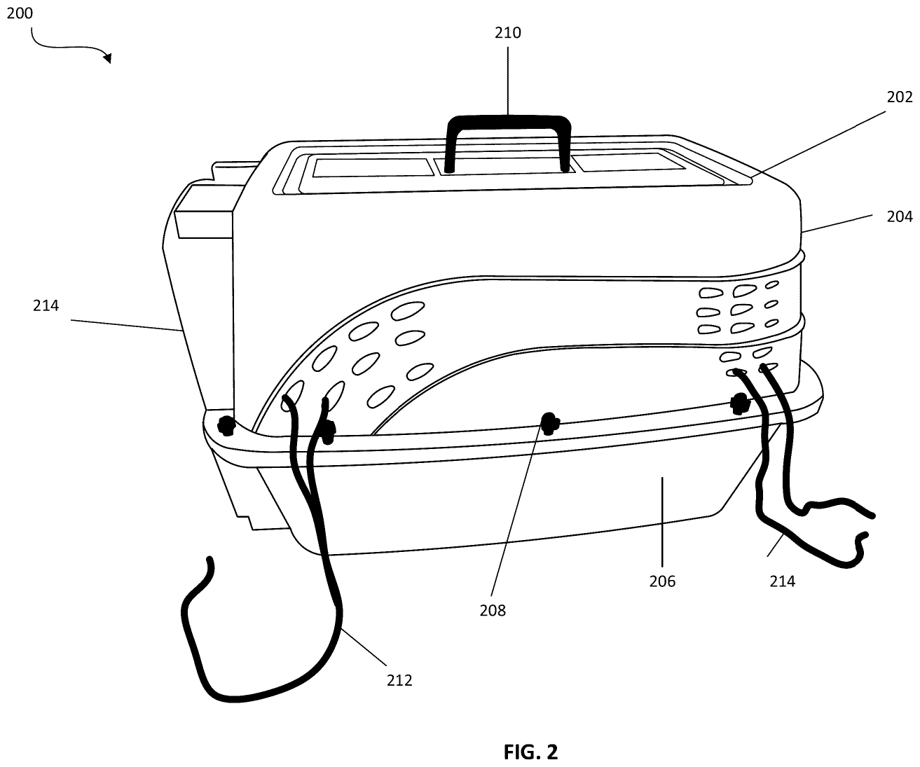

FIG. 2 is an illustration of a pet crate 200, according to one or more embodiments. A pet crate 200 can include a housing 202 that includes a first housing 204 and a second housing 206 that can be connected to the first housing 204. As seen, the housing 202 can include a box-like structure that includes the first housing 204 and the second housing 206. The first housing 204 can be connected to the second housing 206 by one or more carrier fasteners 208, such as a bolt. In some embodiments, the housing 202 can include single housing, such that rather than have a first housing connected to a second housing, the housing 202 can be fabricated as a single structure. The pet crate 200 can further include a handle 210 connected to the housing 202 for permitting a user to carry the pet crate 200.

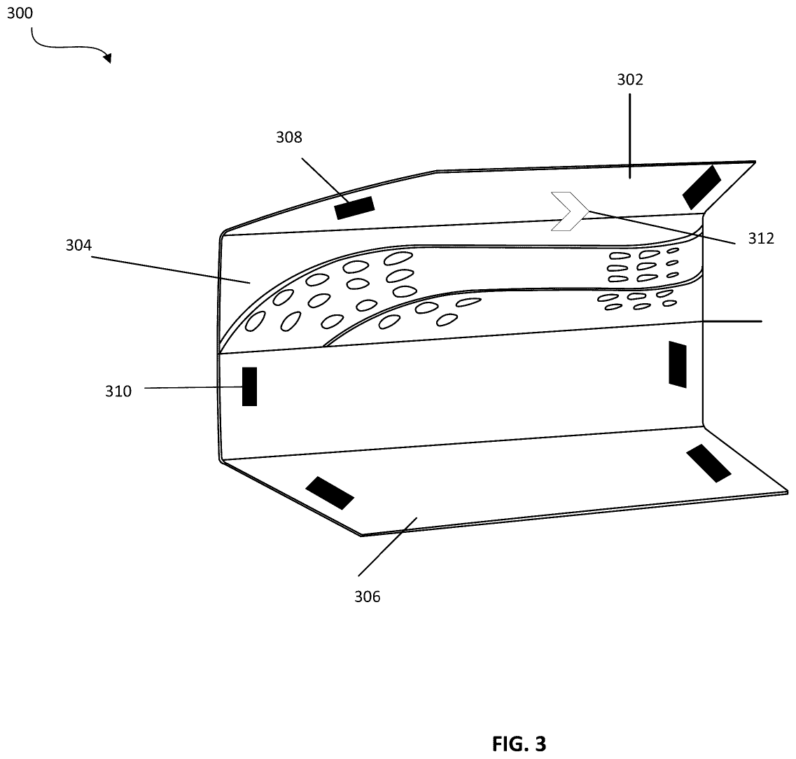

A pet safety carrier can be arranged in the pet crate 200. The pet safety carrier is described in more particularly with respect to FIG. 3. In some embodiments, the pet safety carrier can include a first opening and a second opening. As suggested above, the first opening and a second opening can be opened or closed, such as with a zipper, Velcro, clip, drawstring, or other appropriate feature. As illustrated, each of the first opening and the second opening can include a drawstring. The first opening can include a first drawstring 212 and the second opening can include a second drawstring 214. As illustrated, the first drawstring 212 and the second drawstring 214 can extend away from the pet crate 200 through one or more orifices of the pet crate 200. It should be appreciated that this is for illustration. Furthermore, that in other instances, the first drawstring 212 and the second drawstring 214 can be arranged in the volume created by the pet crate 200. A user can use the first drawstring 212 and the second drawstring 214 to open or close the first opening and the second opening.

The pet crate 200 can further include a mount connected to the pet crate 200. The mount can be arranged inward from a surface of the pet crate 200. The mount can assume various forms, such as a hook, Velcro, clip, button, strap, or other mount operable to mount the pet safety carrier to a surface of the pet crate 200. In some embodiments, the pet crate 200 can include multiple mounts arrange on an inner surface of the pet crate 200. The mounts can be arranged throughout the inner surface, for example, proximate to a pet crate opening, on the inner surface of the pet crate 200. The mounts can be used to removeable connect a pet safety carrier to the pet crate 200. In some embodiments, the mounts are configured, so that when mounted, the pet safety carrier creates a forms a large volume to allow the pet to move freely about.

FIG. 3 is an illustration of a pet crate 300, according to one or more embodiments. For illustration purposes, the pet crate 300 includes a top wall 302, a side wall 304, and a bottom wall 306. An opposing side wall, a gated wall, and an opposing wall to the gated wall have been left out to view the interior of the pet crate. The pet crate 300 and form a volume can be a living space, in which the pet can remain while being transported. As indicated above, the pet crate 300 can include one or more mounts connected to the inner surface of the carrier. In some embodiments, a pet safety carrier can include one or more mounting features that can be used to removably attach the pet safety carrier to the pet crate 300.

Further, for illustration purposes, various forms of mounts are shown in FIG. 3. The mounts can be connected to one or more walls of the pet crate 300. In some embodiments, the mounts can be arranged proximate to a gated wall and an opposing wall to the gated wall. For an example of mounts arranged proximate to the gated wall see, also, FIG. 1. The mounts, when connected to the pet safety carrier, can cause the pet safety carrier to be in an expanded state. For example, a pet crate 300 can include a mount on the top wall 302, side wall 304, and the opposing side wall. As illustrated, a first mount 308 is connected to an inner surface of the top wall 302 and proximate to a gated wall. As further illustrated, a second mount 310 can also be arranged on the top wall 302. In some instances, the first mount 308 can be removably connected on or about an opening of the pet safety carrier. The second mount 310 can be removably connected to a body of the pet safety carrier. In this sense, the first mount 308 can assist in keeping the opening wide enough to allow the pet to enter the pet safety carrier. The second mount 310 can assist in keeping the body in an expanded state to provide a living space for the pet. Each mount can take the form of Velcro, a clip, a button, or other form of mount. If a pet safety carrier were to be connected to a mount, the mount can prevent the pet safety carrier from collapsing onto the bottom wall 306 due to gravity. For example, as seen in FIG. 1, the pet safety carrier opening 114 is being prevented from collapsing onto the bottom wall by being removably connected to the first mount 118.

The pet crate 300 can include an array of mounts that form a system to keep the pet safety carrier open and include a volume for the pet to comfortably stay in while transported. For example, as indicated above, the pet crate 300 can include the second mount 310 arranged near the center of the top wall 302. For example, the second mount 310 can be arranged opposite a handle on the outer surface of the top wall 302. This second mount 310 can, when secured to a pet safety carrier, prevent a body from collapsing onto the bottom wall. The pet crate 300 can further include a third mount 312 connected to the inner surface of the top wall 302. The third mount 312 can be removably connected to the top wall proximate to an opposing wall of the gated wall. The third mount 312 can be removably connected to a second opening of the pet safety carrier. The third mount 312, when secured to the pet safety carrier can prevent the second opening of the pet safety carrier from collapsing.

As seen, the pet crate 300 includes three mounts proximate to the gated wall. The pet crate 300 can include a fourth mount 312 on an inner surface of the side wall 304. The fourth mount 312, when removably connected to the pet safety carrier can keep the opening of the pet safety carrier wide enough to allow a pet to enter. The pet crate 300 can further include a fifth mount 314 on the bottom wall 316. It should be appreciated that although FIG. 3 illustrates a first mount 306, a second mount 308, a third mount 310, a fourth mount 312 and a fifth mount 314, various configurations for mounting a pet safety carrier can be included. For example, the first mount 306, the fourth mount 312, and the fifth mount 314 can be a single mount that is arranged around the inner circumference of the pet crate 300 and proximate to the gated wall. Furthermore, the mounts on the inner surface of the pet crate 300 proximate to the opposing wall of the gated wall can be arranged similarly to the mounts arranged proximate to the gated wall. In some instances, the arrangement of one or more mounts proximate to the opposing wall to the gated wall mirrors an arrangement of the one or mounts proximate to the gated wall.

It should be appreciated that the pet crate 300 can include any number of mounts on the inner surface of the top wall 302. For example, the inner surface of the top wall 302 can include a single piece of Velcro that extends across the inner surface of the top wall 302 from the gated wall to the opposite wall. In other embodiments, the inner surface of the top wall 302 can include zero mounts. This would be the instance that the side wall 304 and the opposing side wall included mounts close enough to top wall 302 that, when connected to the pet safety carrier, prevent the carrier from collapsing onto the bottom wall.

In addition to one or more mounts on the top wall 302, the pet crate 300 can include mounts on the side wall 304. Although not illustrated, the opposing side wall can also include mounts. For illustration purposes, the side wall 304 includes a sixth mount 318 and an opposing side wall can also include a mount arranged similarly to the sixth mount 318. The mounts can be arranged on the side wall 304 and the opposing side wall in a variety of arrangements. For example, in some embodiments, in which the side wall 304 is a combination of a top housing and bottom housing, the pet crate 300 can include a mount on a top housing and a mount on a second housing. In other embodiments, in which the pet crate 300 is a single housing, the pet crate 300 includes at least one mount on the side wall 304. The side wall 304 and the opposing side wall can include a respective mount that, when connected to the pet safety carrier, can hold the pet safety carrier in an expanded state. Each of the mounts on the side wall 304 and the opposing side wall can prevent the pet safety carrier from collapsing inward or onto the bottom wall 316. For example, the side wall 304 can include three mounts arranged similarly to the top wall 302 (e.g., a mount proximate to the gated wall, a mount centrally located on the side wall 304, and an opposing wall to the gated wall).

In some embodiments, the pet crate 300 can include mounts for connecting to the bottom wall 316 of the pet safety carrier. These mounts can secure the pet safety carrier to the bottom wall 316 to prevent the pet safety carrier from moving about while being transported.

The pet safety carrier can include corresponding mounts for the pet crate mounts. For example, if the first mount 308 is Velcro, the pet safety carrier can include a corresponding piece of Velcro for connecting to the Velcro mount on the first mount 306. In this sense, the pet crate 300 and the pet safety carrier can be a system that creates a safe living space for the pet through expansion of the pet safety carrier using the mounts.

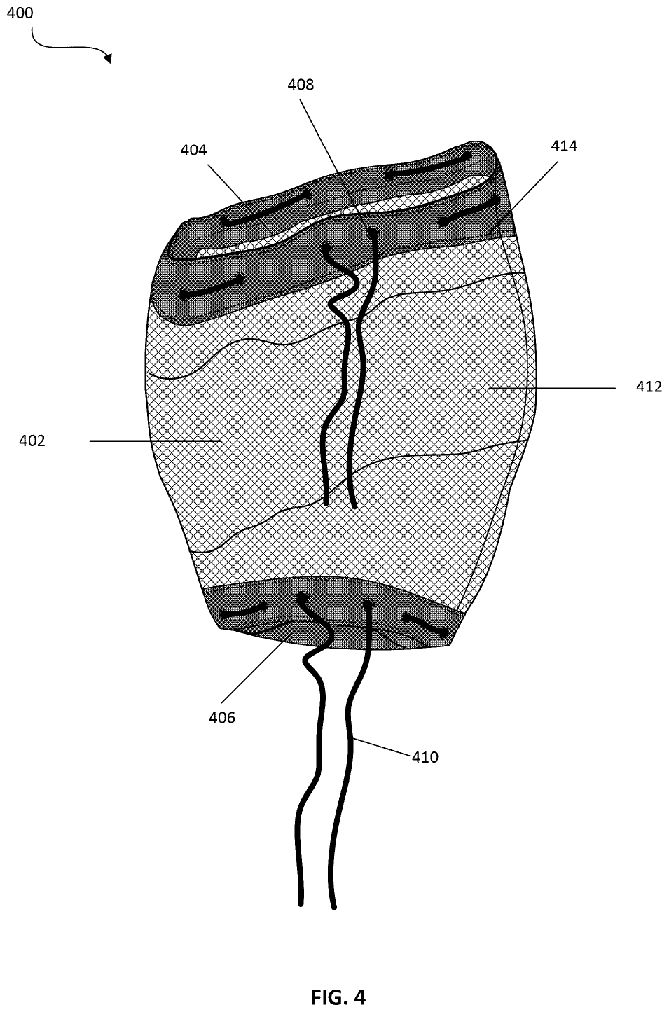

FIG. 4 is an illustration 400 of a ventilated pet safety carrier, according to one or more embodiments. The ventilated pet safety carrier 402 can include a first opening 404 and a second opening 406. The first opening 404 and the second opening 406 can each be opened or closed, such as with a zipper, Velcro, clip, drawstring, button, or other appropriate feature. As illustrated, the ventilated pet safety carrier 402 can include a first drawstring 408 and a second drawstring 410. The first drawstring 408 can be used to expand or contract the first opening 404. The second drawstring can be used to expend or contract the second opening 406. Each of the first opening 404 and the second opening 406 can be used by a small animal for ingress and egress. In other embodiments, the ventilated pet safety carrier 402 can include a zipper, Velcro, clip, button, or other appropriate feature. The first drawstring 408 can be used to open or close the first opening 404, and the second drawstring 410 can be used to open or close the second opening 406. The body 412 of the ventilated pet safety carrier 402 can be configured to have a size large enough to hold a pet, such as a cat or a dog. In the instance that the ventilated pet safety carrier 402 is mounted to a pet crate and in an expanded state, the volume that forms the living space for the pet can be inward from the body of the ventilated pet safety carrier 402.

The ventilated pet safety carrier 402 can be fabricated from various materials. For example, the ventilated pet safety carrier 402 can be fabricated from a mesh material (e.g., spun mesh or filament mesh) that includes a plurality of holes. The holes can be large enough to allow air to pass through to allow the pet to breathe. The ventilated pet safety carrier 402 can include a configurable number of holes that allows air to pass through the ventilated pet safety carrier, such that the pet can breathe.

In some embodiments, the ventilated pet safety carrier 402 includes a protective material 412 about the first drawstring 408 about the second drawstring 410. For illustration and brevity purposes the protective material 414 is described about the first drawstring 408. In some embodiments, the protective material is also arranged about the second drawstring 410. The protective material 414 can include an opening that permits the ends of the first drawstring 408 to extend through the opening. The protective material 414 can be a different material than a balance of the material of the ventilated pet safety carrier 402. The protective material 414 can further be attached to the ventilated pet safety carrier 402. For example, the protective material 414 can be affixed to an inner surface of the ventilated pet safety carrier 402, an outer surface of the ventilated pet safety carrier 402, or sown into the ventilated pet safety carrier 402. The protective material 414 can help protect a user that is attempting to open or close a ventilated pet safety carrier opening using the first drawstring 408. For example, the protective material 414 can be a piece of leather, synthetic leather, or other nonperforated material that the first drawstring 408 can extend through. The protective material 414 can have a width that is similar to a width of a user's hands (e.g., four inches, five inches). In the event a user is attempting to manipulate the first drawstring 408 to open or close an opening, the protective material 414 can guard against a pet scratching or biting at the user's hands. As illustrated, the second drawstring 410 has been pulled from the protective material to cause the second opening 406 to close more than the first opening 404. In a closed position, the protective material can bunch up and protect a user's hands near the second drawstring 410 from a pet inside the ventilated pet safety carrier 402.

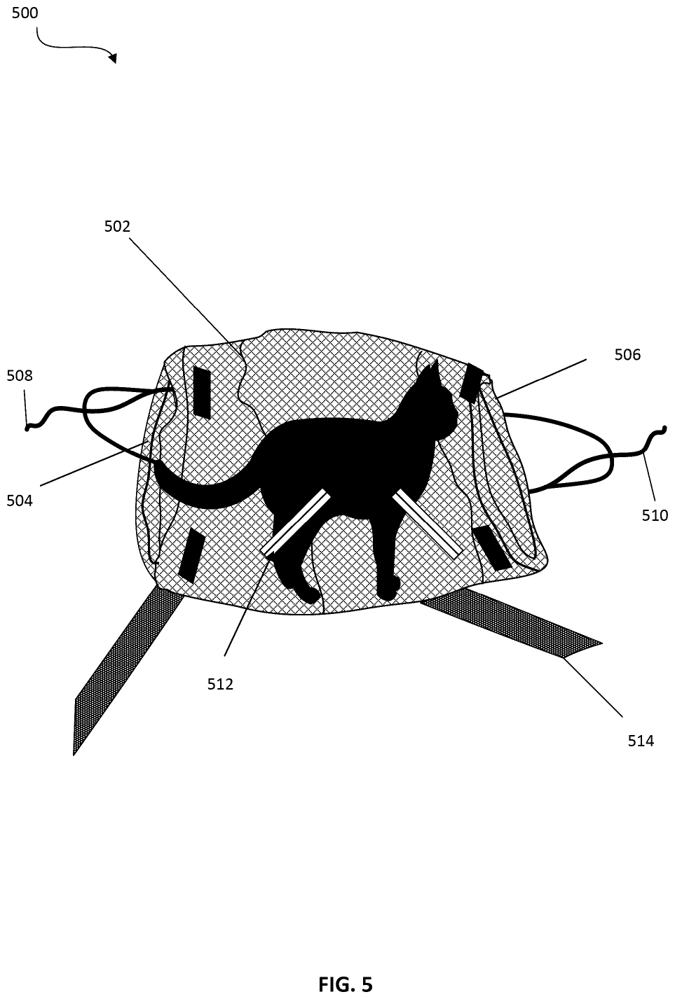

FIG. 5 is an illustration 500 of a ventilated pet safety carrier, according to one or more embodiments. The ventilated pet safety carrier 502 can include a first opening 504 and a second opening 506. The first opening 504 and the second opening 506 can each be opened or closed with a first fastening feature, such as with a zipper, Velcro, drawstring, clip, button, or other appropriate feature. As illustrated, the ventilated pet safety carrier 502 can include a first drawstring 508 and a second drawstring 510. In addition, the ventilated pet safety carrier 502 can include one or more targeted openings 512. A targeted opening 512 can include a second fastening feature, for example, a zipper, Velcro, clip, drawstring, button, or other appropriate feature similar to the first opening 504 and the second opening 506. A targeted opening 512 can be arranged, such that the targeted opening 512 would be proximate to an area of interest on a pet. For example, the one targeted opening 512 can be spaced apart from another targeted opening 512 at a distance that would permit the user to pull out a pet leg or pet arm from one targeted opening 512 and another pet arm or pet leg from another targeted opening 512.

The ventilated pet safety carrier 502 can be in an expanded state or a collapsed state. The expanded state can include a stretched state or an unstretched state. In the expanded state, the ventilated pet safety carrier 502 can be configured to have a volume that creates a living space for the pet. The dimensions of the ventilated pet safety carrier 502 can be configured to create a volume that provides the pet ample room for resting in a pet crate. As illustrated, the ventilated pet safety carrier 502 is in an expanded state and a pet is in the living space. For example, in some instances, a ventilated pet safety carrier 502 can be configured for a smaller animal, such as a cat. In other instances, the ventilated pet safety carrier 502 can be configured for a smaller animal, such as a dog. In other instances, the dimensions of the ventilated pet safety carrier 502 can be configured for the dimensions of a pet crate. For example, the dimensions of the ventilated pet safety carrier 502 can be configured for the mounts attached to the inner surface of the pet crate. While in the expanded state, the pet can move about the volume created by the ventilated pet safety carrier 502. The pet can stand upright, lie down, face one direction or turn and face another direction. The ventilated pet safety carrier 502 can further be perforated, allowing the pet to breathe freely while in the ventilated pet safety carrier 502.

In addition, the ventilated pet safety carrier 502 can further include one or more safety restraint 514. The safety restraint 514 can, be for example, a strap or a band. The safety restraint 514 can be configured to have a length, such that the safety restraint 514 can be wrapped around the ventilated pet safety carrier 502 and the pet. The safety restraint can further include a fastener, such as a zipper, Velcro, clip, or a button to hold the safety restraint in place. For example, the veterinarian's assistant or the veterinarian can wrap the safety restraint 514 around the ventilated pet safety carrier 502 where the pats hind legs are to prevent the pet from kicking the veterinarian's assistant or the veterinarian. One end of the safety restraint 514 can include a first fastener (e.g., first Velcro) and the second end of the safety restraint can include a second fastener (e.g., second Velcro). The veterinarian's assistant or the veterinarian can wrap the safety restraint 514 over the ventilated pet safety carrier 502 and around the hind legs. For example, if a pet is being uncooperative, the safety restraint can be applied to prevent the pet from self-harm or from harming the veterinarian's staff. The veterinarian's assistant or the veterinarian can fasten the first fastener to the second fastener to hold the safety restraint in place. Once the veterinarian's assistant or the veterinarian has completed, the veterinarian's assistant or the veterinarian can loosen the safety restraint 514. The ventilated pet safety carrier 502 can further include mounting feature 516. The mounting feature 516 can correspond to a mount on a pet crate. For example, if the pet crate includes a mount in the form of a hook, the mounting feature can be a band that can attach to the hook. Or, for example, if the pet crate includes a mount in the form of Velcro, the ventilated pet safety carrier 502 can include a corresponding mounting feature 516 in the form of a Velcro strap to removably attach to the Velcro mount of the pet crate.

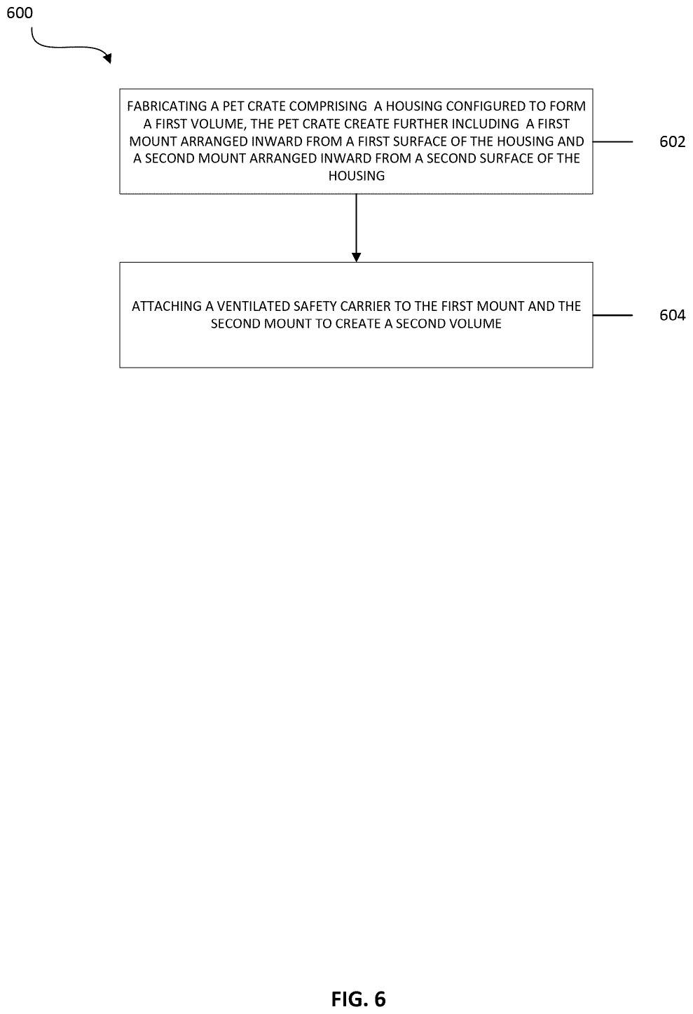

FIG. 6 is a process flow 600 for fabricating a portable pet crate with a ventilated pet safety carrier, according to one or more embodiments. At 602, the method can include obtaining a pet crate, the pet crate including a surface configured to form a volume, the pet crate further including the first mount arranged inward from a surface of the pet crate and a second mount arranged inward from a surface of the pet crate. It should be appreciated that obtaining can include receiving, purchasing, or otherwise becoming in possession of the pet crate.

The pet crate can include a housing formed from multiple walls, which each wall can be considered a surface. The walls can be arranged to form a first volume inward from each wall. The first volume can form a living space for a pet. In some instances, the housing includes a first housing and a second housing that can be connected to the first housing. For example, the first housing can include a wing connected to a wing of the second housing by one or more carrier fasteners, such as a bolt. In some embodiments, the first housing can further include a flap on a top surface of the housing. The flap can be rotated to open and expose the volume. In other embodiments, the housing can include single housing, such that rather than have a first housing connected to a second housing, the housing can be fabricated as a single structure. The pet crate can further include a handle connected to the housing for permitting a user to carry the pet crate. In some instances, the handle is connected to the flap.

At 604, the method can include attaching a ventilated pet safety carrier to the first mount and the second mount to create a second volume. The ventilated pet safety carrier can include a first opening and a second opening. The first opening and the second opening can each be opened or closed using a first fastening feature, such as with a zipper, Velcro, drawstring, clip, button, or other appropriate feature. In addition, the ventilated pet safety carrier can include one or more targeted openings arranged about the ventilated pet safety carrier. A targeted opening can include an orifice and a second fastening feature, for example, a zipper, Velcro, clip, drawstring, button, or other appropriate feature. A targeted opening can be arranged, such that the targeted opening would be proximate to an area of interest on a pet.

The pet crate can further include a first mount and a second mount. The first mount and the second mount can each be arranged inward from a surface of the pet crate. The first mount and the second mount can assume various forms, such as a hook, Velcro, clip, button, strap, or other mount operable to mount the ventilated pet safety carrier to a surface of the pet crate. The first mount and a second mount can be used to removably connect the ventilated pet safety carrier to the pet crate. The first mount and the second mount can be configured such that, when mounted, the ventilated pet safety carrier creates a large volume to allow the pet to move freely about.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A pet crate safety system, comprising:
a plurality of walls forming a housing of a pet crate, the plurality of walls arranged to form a first volume;
a mount arranged on a first surface of a wall of the plurality of walls; and
a ventilated pet safety carrier configured to be removably mounted to the mount and arranged in the volume, the ventilated pet safety carrier further configured to form a second volume when attached to the mount such that a pet can be contained in the second volume and not in a remaining portion of the pet crate.

2. The pet crate safety system of claim 1, wherein the ventilated pet safety carrier comprises:
an opening; and
a perforated material configured to be in a collapsed state or an expanded state, wherein the ventilated pet safety carrier forms the second volume while in the expanded state.

3. The pet crate safety system of claim 2, wherein the ventilated pet safety carrier further comprises a fastening feature configured to expand or contract the opening.

4. The pet crate safety system of claim 3, wherein the fastening feature is a drawstring, Velcro, clip, button, or zipper.

5. The pet crate safety system of claim 4, wherein the opening is a first opening, wherein the fastening feature is a first fastening feature, wherein the ventilated pet safety carrier further comprises a second opening and a third opening, wherein the first opening and the second opening being configured for ingress and egress to and from the ventilated pet safety carrier by a pet, wherein the third opening comprising a second fastening feature, and wherein the third opening is configured to expose a portion of the pet.

6. The pet crate safety system of claim 1, wherein the ventilated pet safety carrier comprises a safety restraint configured to wrap around the ventilated pet safety carrier.

7. The pet crate safety system of claim 6, wherein the safety restraint is a strap or a band.

8. The pet crate safety system of claim 1, wherein the housing comprises a first housing and a second housing, wherein the first housing is configured to be removably connected to the second housing, and wherein the mount is connected to an inner surface of the first housing.

9. The pet crate safety system of claim 1, wherein the housing comprises a first housing and a second housing, wherein the first housing is configured to be removably connected to the second housing, and wherein the mount is connected to an inner surface of the second housing.

10. The pet crate safety system of claim 1, wherein the housing comprises a single housing, and wherein the mount is connected to an inner surface of the single housing.

11. A pet safety system, comprising:
a ventilated pet safety carrier configured to be removably mounted to a mount of a pet container, the ventilated pet safety carrier further configured to form a volume when attached to the mount, wherein the ventilated pet safety carrier comprises an opening and a perforated material configured to be in a collapsed state or an expanded state, and wherein the ventilated pet safety carrier forms a volume while in the expanded state such that a pet can be contained in the volume and not in a remaining portion of the pet container.

12. The safety system of claim 11, wherein the ventilated pet safety carrier further comprises a fastening feature configured to expand or contract the opening.

13. The safety system of claim 12, wherein the fastening feature is a drawstring, Velcro, button, or zipper.

14. The safety system of claim 12, wherein the opening is a first opening, wherein the fastening feature is a first fastening feature, wherein the ventilated pet safety carrier further comprises a second opening and a third opening, wherein the first opening and the second opening being configured for ingress and egress to and from the ventilated pet safety carrier by a pet, wherein the third opening comprising a second fastening feature, and wherein the third opening is configured to expose a portion of the pet.

15. The safety system of claim 11, wherein the ventilated pet safety carrier comprises a safety restraint configured to wrap around the ventilated pet safety carrier.

16. The safety system of claim 15, wherein the safety restraint is a strap or a band,

17. A method, comprising:
obtaining a pet crate comprising a housing configured to form a first volume, the pet crate further comprising a first mount arranged inward from a first surface of the housing, and a second mount arranged inward from a second surface of the housing; and
attaching a ventilated pet safety carrier to first mount and the second mount to create a second volume, wherein the ventilated pet safety carrier comprises an opening and a perforated material configured to be in a collapsed state or an expanded state, wherein the ventilated pet safety carrier forms the second volume while in the expanded state such that a pet can be contained in the second volume and not in a remaining portion of the pet crate.

18. The method of claim 17, wherein the ventilated pet safety carrier further comprises a fastening feature configured to expand or contract an opening.

19. The method of claim 18, wherein the fastening feature is a drawstring, Velcro, button, or zipper

20. The method of claim 17, wherein the ventilated pet safety carrier further comprises a safety restraint configured to wrap around the ventilated pet safety carrier.
